(19) United States
(12) Patent Application Publication
(10) Pub. No.: US 2011/0234707 A1
(43) Pub. Date: Sep. 29, 2011

(54) LIQUID EJECTING HEAD, LIQUID EJECTING HEAD UNIT, AND LIQUID EJECTING APPARATUS

(75) Inventor: Yue Gao, Matsumoto-shi (JP)

(73) Assignee: SEIKO EPSON CORPORATION, Shinjuku-ku (JP)

(21) Appl. No.: 13/069,339

(22) Filed: Mar. 22, 2011

(30) Foreign Application Priority Data
Mar. 23, 2010 (JP) 2010-065857

(51) Int. Cl. B41J 2/045

(52) U.S. Cl. 347/70

(57) ABSTRACT

A piezoelectric element including a first electrode serving as an individual electrode, a piezoelectric layer, and a second electrode serving as a common electrode is attached on a face of a flow path substrate via a vibrating plate. A piezoelectric active portion defined by the first electrode and the second electrode serving as a substantial driver of the piezoelectric element is provided in a region opposing the pressure chamber. An opening formed by removing the second electrode and the piezoelectric layer is provided in a region of the piezoelectric element opposing the partition wall. A wiring electrode and the second electrode provided on the flow path substrate are connected via a common lead electrode provided on the piezoelectric active portion, and the common lead electrode is provided at least on the partition wall inside the opening.

The entire disclosure of Japanese Patent Application No: 2010-065857, filed Mar. 23, 2010 are expressly incorporated by reference herein.

### BACKGROUND

1. Technical Field

The present invention relates to a liquid ejecting head, a liquid ejecting head unit, and a liquid ejecting apparatus that eject a liquid through a nozzle opening, and more particularly to an ink jet recording head, an ink jet recording head unit, and an ink jet recording apparatus that discharge ink as an example of the liquid.

2. Related Art

The liquid ejecting head can be exemplified by an ink jet recording head that includes a flow path substrate in which pressure chambers communicating with nozzle openings are defined in a row by partition walls, and a piezoelectric element including a first electrode, a piezoelectric layer, and a second electrode provided on a face of the flow path substrate via a vibrating plate. The liquid ejecting head causes pressure fluctuation in the pressure chambers by vibration of the piezoelectric element, thereby discharging ink droplets through the nozzle openings.

For example, JP-A-2009-172878 (in particular, FIGS. 2 and 4) proposes an ink jet recording head in which the first electrode of the piezoelectric element on the side of the vibrating plate is divided into individual electrodes corresponding to the respective pressure chambers, while the second electrode is a continuously formed common electrode shared by the plurality of pressure chambers.

In the ink jet recording head, one of the electrodes of the piezoelectric element serves as the common electrode of the plurality of piezoelectric elements. Therefore, in the case where a number of piezoelectric elements are simultaneously driven to discharge ink droplets at a time, the voltage drops and amount of displacement of the piezoelectric element becomes unstable, resulting in degradation in ink discharging characteristic. Besides, the piezoelectric element located farther from a terminal to be connected to an external wiring is more prone to suffer the voltage drop.

To cope with such a drawback, for example JP-A-2007-118265 proposes an ink jet recording head in which a wiring electrode is provided in a direction in which the pressure chambers are aligned, such that the first electrode and the wiring electrode are connected via one of common lead electrodes, each provided per a certain number of piezoelectric elements.

In the case where the first electrode serves as the individual electrode and the second electrode serves as the common electrode as illustrated in FIGS. 2 and 4 in JP-A-2009-172878, it would be appropriate to continuously form the piezoelectric layer and the second electrode so as to correspond to the plurality of pressure chambers. Such a configuration, however, may cause what is known as a crosstalk between the piezoelectric elements, a phenomenon that the piezoelectric layer and the second electrode continuously provided between the adjacent piezoelectric elements interfere with the displacement of those piezoelectric elements, thereby degrading the displacement characteristic.

In the case where a portion of the piezoelectric layer and the second electrode corresponding to the partition wall defining the pressure chambers is removed so as to form an opening on the partition wall, the rigidity of the partition wall is degraded. Moreover, the increase in density of the nozzle openings causes the partition wall to be made thinner, resulting in significant compromise in rigidity of the partition wall. Accordingly, the partition wall readily suffers deformation because of pressure fluctuation in the pressure chamber, which causes what is known as a crosstalk through the partition wall, a phenomenon that the pressure fluctuation is transmitted to the adjacent pressure chambers, resulting in deviation of ink droplet landing position and degradation in ink discharging characteristic.

### SUMMARY

An advantage of some aspects of the invention is that a liquid ejecting head, a liquid ejecting head unit, and a liquid ejecting apparatus are provided that can suppress a crosstalk between piezoelectric elements and through a partition wall, as well as a voltage drop, thereby suppressing deviation of ink droplet landing position and stabilizing liquid ejection characteristic, thus contributing to improving printing quality.

In one aspect, the invention provides a liquid ejecting head including a flow path substrate including a plurality of pressure chambers communicating with nozzle openings through which a liquid is ejected, the pressure chambers being defined by a partition wall so as to be aligned in a first direction; and a piezoelectric element including a first electrode provided on a face of the flow path substrate via a vibrating plate, a piezoelectric layer provided on the first electrode, and a second electrode provided on the piezoelectric layer. The first electrode of the piezoelectric element serves as an individual electrode corresponding to each of the pressure chambers. The second electrode serves as a common electrode continuously formed along a plurality of piezoelectric elements. The piezoelectric element includes a piezoelectric active portion defined by the first electrode and the second electrode and substantially acting as a driver of the piezoelectric element, the piezoelectric active portion being located in a region opposing the pressure chamber. An opening formed by removing a portion of the second electrode and the piezoelectric layer is provided in a region of the piezoelectric element opposing the partition wall, the opening being narrower than the piezoelectric active portion in a second direction intersecting with the first direction and wider than a thickness of the partition wall in the first direction. A wiring electrode extending in a direction in which the piezoelectric active portions are aligned is provided at least on one side in the second direction of a row of the piezoelectric active portions aligned. The wiring electrode and the second electrode are connected via a common lead electrode provided between the piezoelectric active portions, and the common lead electrode is provided at least on a portion of the partition wall inside the opening.

According to the aspect, the common lead electrode is provided between the piezoelectric active portions, which reduces substantial resistance of the second electrode, thereby suppressing degradation and fluctuation of liquid ejection characteristic originating from a voltage drop. In addition, the common lead electrode is provided in the region corresponding to a portion of the partition wall opposing the opening, which increases rigidity of the partition wall, thereby contributing to suppressing the crosstalk through the partition wall and to increasing the density of the pressure chambers, as the partition wall can be made thinner.

It is preferable that a portion of the common lead electrode opposing the opening is made narrower than the thickness of the partition wall. Such a configuration suppress interference from the common lead electrode with the displacement of the vibrating plate caused by the piezoelectric active portion, thereby suppressing degradation in liquid ejection characteristic.

It is preferable that the wiring electrode is provided on both sides in the second direction of the aligned piezoelectric elements, and the second electrode is electrically connected to the wiring electrode on the respective sides in the second direction of the piezoelectric elements, via the common lead electrode. With such an arrangement, the wiring electrode contributes to further reducing the substantial resistance of the second electrode, and the wiring electrode can be made narrower, so that the liquid ejecting head can be made smaller in size.

In another aspect, the invention provides a liquid ejecting head unit including a plurality of liquid ejecting heads according to the foregoing aspect.

The liquid ejecting head unit thus configured can suppress the crosstalk between the piezoelectric elements and through the partition wall, as well as a voltage drop, thereby suppressing deviation of ink droplet landing position and stabilizing the liquid ejection characteristic, thus contributing to improving printing quality.

In still another aspect, the invention provides a liquid ejecting apparatus including the liquid ejecting head or the liquid ejecting head unit according to the foregoing aspects.

The liquid ejecting apparatus thus configured can suppress the crosstalk between the piezoelectric elements and through the partition wall, as well as a voltage drop, thereby suppressing deviation of ink droplet landing position and stabilizing the liquid ejection characteristic, thus contributing to improving printing quality.

### BRIEF DESCRIPTION OF THE DRAWINGS

The invention will be described with reference to the accompanying drawings, wherein like numbers reference like elements.

FIG. 1 is an exploded perspective view showing a recording head according to a first embodiment.

FIGS. 2A and 2B are fragmentary plan views of the recording head according to the first embodiment, FIG. 2B being an enlargement of a portion of FIG. 2A.

FIG. 3 is a cross-sectional view of the recording head according to the first embodiment.

FIG. 4 is another cross-sectional view of the recording head according to the first embodiment.

FIG. 5 is still another cross-sectional view of the recording head according to the first embodiment.

FIG. 6 is an enlarged fragmentary plan view of a recording head according to a second embodiment.

FIG. 7 is a schematic perspective view showing a recording apparatus according to an embodiment.

### DESCRIPTION OF EXEMPLARY EMBODIMENTS

Hereafter, embodiments of the invention will be described, referring to the drawings.

### First Embodiment

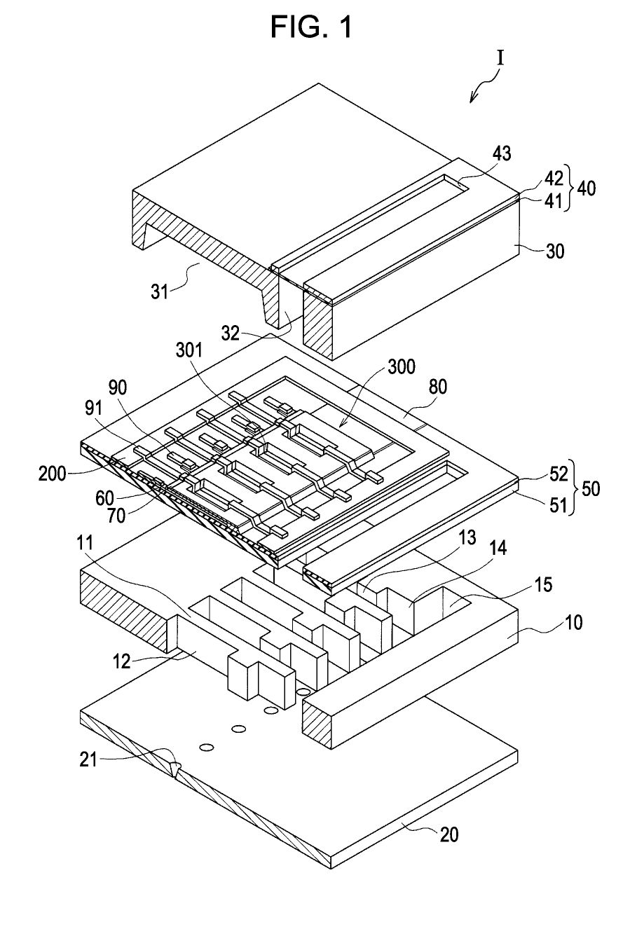

FIG. 1 is an exploded perspective view illustrating an ink jet recording head according to a first embodiment, exemplifying the liquid ejecting head of the invention.

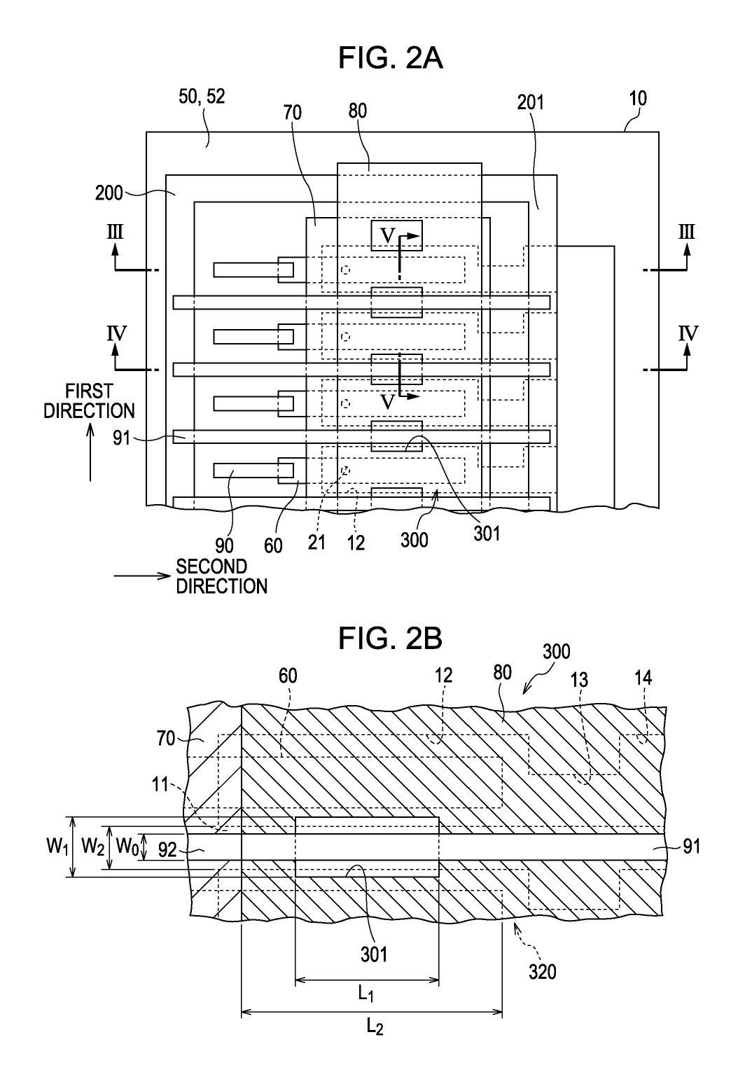

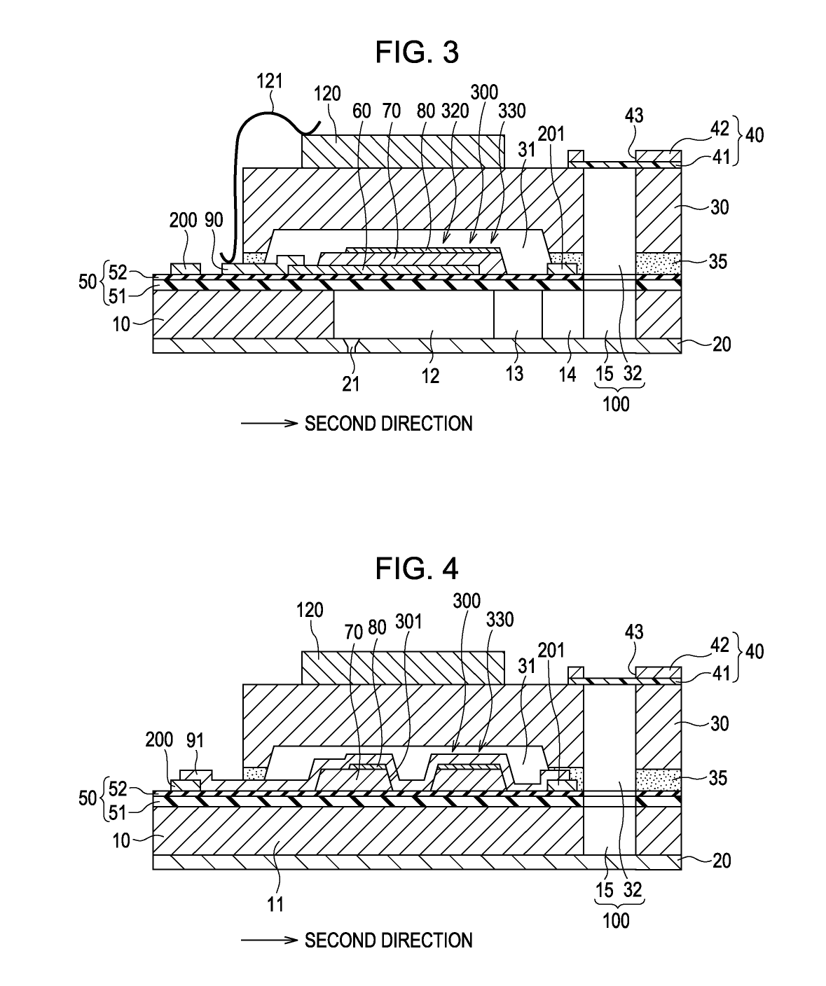

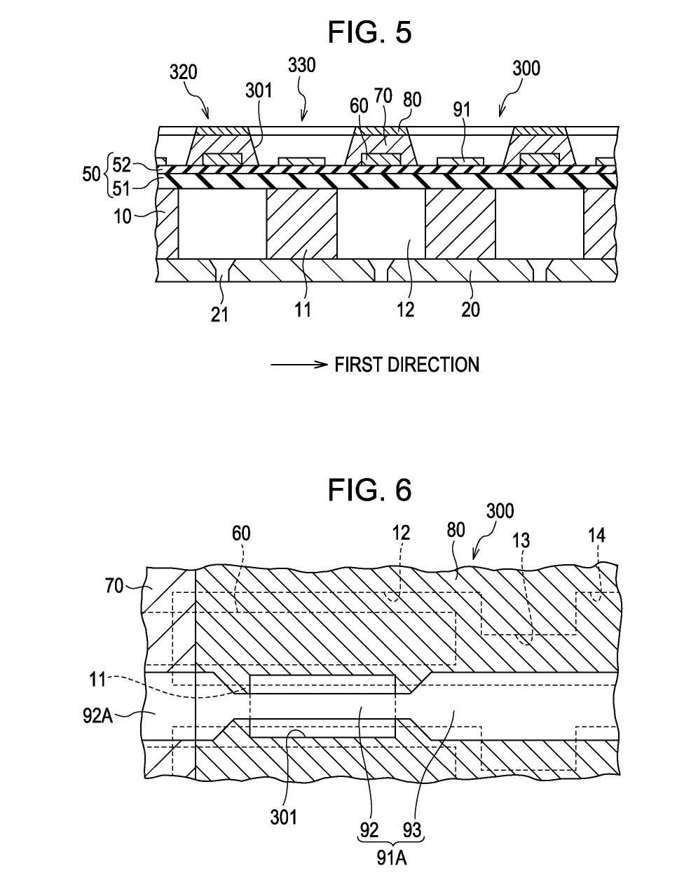

FIGS. 2A and 2B are fragmentary plan views of a flow path substrate of the ink jet recording head, FIG. 2B being an enlargement of a portion of FIG. 2A. FIG. 3 is a cross-sectional view taken along a line III-III in FIG. 2A. FIG. 4 is a cross-sectional view taken along a line IV-IV in FIG. 2A. FIG. 5 is a cross-sectional view taken along a line V-V in FIG. 2A.

As illustrated in FIG. 1, the flow path substrate 10 constituting a part of the ink jet recording head I includes a plurality of pressure chambers 12 defined by a partition wall 11, aligned in a widthwise direction thereof (in a direction of shorter sides, hereinafter referred to as first direction in this embodiment). The flow path substrate 10 also includes an ink supply path 13 and a pressure chamber port 14 defined by the partition wall 11 so as to communicate with the pressure chamber 12, and located on an end portion of the pressure chamber 12 in a longitudinal direction thereof. Also, a communication channel 15 communicating with each pressure chamber port 14 is provided on an outer side thereof.

The communication channel 15 communicates with a manifold stem portion 32 of a cover substrate 30 to be subsequently described, thereby constituting a part of a manifold 100 that serves as a common ink chamber (liquid chamber) shared by the pressure chambers 12. The ink supply path 13 is formed to have a cross-sectional area smaller than that of the pressure chamber 12, so that a flow path resistance against the ink introduced into the pressure chamber 12 through the communication channel 15 is maintained at a constant level. The pressure chamber port 14 is formed by extending the partition wall 11 on the respective sides of the pressure chamber 12 toward the communication channel 15 so as to divide the space between the ink supply path 13 and the communication channel 15.

For example, a silicon monocrystalline substrate is typically employed to form the flow path substrate 10. Alternatively, a glass ceramic or a stainless steel may also be employed.

A nozzle plate 20 perforated with nozzle openings 21 is attached to one of the faces of the flow path substrate 10 via an adhesive or a heat sealing film. The nozzle plate 20 may be made of, for example, a glass ceramic, a silicon monocrystalline substrate, or a stainless steel.

On the opposite face of the flow path substrate 10, a vibrating plate 50 is provided including an elastic film 51 that can be formed, for example, by thermally oxidizing the flow path substrate 10. One of the sides of the pressure chambers 12 and the flow paths is formed of the vibrating plate 50 (elastic film 51).

In this embodiment, an insulating film 52, formed of an oxide film of a material different from that of the elastic film 51, is provided on the elastic film 51, and the elastic film 51 and the insulating film 52 constitute the vibrating plate 50. On the vibrating plate 50 thus configured, a piezoelectric element 300 is provided including a first electrode 60 formed on the vibrating plate 50, a piezoelectric layer 70 formed on the first electrode 60, and a second electrode 80 formed on the piezoelectric layer 70.

In the piezoelectric element 300, ordinarily, one of the electrodes serves as a common electrode and the other serves as an individual electrode working independently from other electrodes. In this embodiment, the first electrode 60 serves as the individual electrode of a piezoelectric active portion 320 that acts as a substantial driver of the piezoelectric element 300, and the second electrode 80 serves as the common electrode shared by the plurality of piezoelectric active portions 320.

The piezoelectric element 300 thus configured and the vibrating plate 50 driven to be displaced by the piezoelectric element 300 constitute an actuator unit. Although the elastic film 51 and the insulating film 52 constitute the vibrating plate 50 in this embodiment, the structure of the vibrating plate 50 is not specifically limited. For example, the first electrode 60 of the piezoelectric element 300 may serve as the vibrating plate 50, or alternatively the piezoelectric element 300 itself may serve as the vibrating plate 50.

Hereunder, the structure of the piezoelectric element 300 according to this embodiment will be described in further details. As illustrated in FIGS. 3 to 5, the piezoelectric element 300 includes the piezoelectric active portion 320 and a piezoelectric non-active portion 330. The piezoelectric active portion 320 includes the first electrode 60, the piezoelectric layer 70, and the second electrode 80 stacked in this order, and incurs piezoelectric distortion when a voltage is applied to the both electrodes. The piezoelectric non-active portion 330 includes the piezoelectric layer 70 continuously extending from the piezoelectric active portion 320 and the first electrode 60 or the second electrode 80, which however is not actually driven. A boundary between the piezoelectric active portion 320 and the piezoelectric non-active portion 330 is defined by an end portion of the first electrode 60 and the second electrode 80. In this embodiment, the piezoelectric active portions 320 are each disposed so as to oppose the pressure chambers 12, and the piezoelectric non-active portion 330 is located on the respective outer sides of the piezoelectric active portion 320 in its longitudinal direction, and extends to an outer region of the pressure chamber 12 in its longitudinal direction (second direction orthogonal to the first direction). Also, the piezoelectric non-active portion 330 is located between the immediately adjacent piezoelectric active portions 320, and extends to an outer region of the pressure chamber 12 in its widthwise direction (first direction). More specifically, as illustrated in FIG. 3, with respect to the longitudinal direction of the pressure chamber 12 (orthogonal to the direction in which the pressure chambers are aligned), an end portion of the piezoelectric active portion 320 on the side of the ink supply path 13 is defined by an end portion of the first electrode 60 in its longitudinal direction, and the piezoelectric layer 70 and the second electrode 80 extend to an outer region of that end portion. In the longitudinal direction of the pressure chamber 12, also, the other end portion of the piezoelectric active portion 320 opposite the ink supply path 13 (on the side of the nozzle opening 21) is defined by an end portion of the second electrode 80, and the first electrode 60 and the piezoelectric layer 70 extend to an outer region of the end portion.

Referring to FIG. 5, the first electrode 60 is formed such that a portion thereof opposing the corresponding pressure chamber 12 becomes narrower than a width of the pressure chamber 12 (width in the first direction in which the pressure chambers 12 are aligned), and the end portion of the first electrode 60 in its widthwise direction defines the end portion of the piezoelectric active portion 320 in its widthwise direction.

Referring again to FIG. 3, an individual lead electrode 90, for example formed of gold (Au), is connected to each first electrode 60 at a position outside an end portion of the pressure chamber 12 in its longitudinal direction (opposite the ink supply path 13), and a driving circuit 120 to be subsequently described in detail is connected to the piezoelectric element 300, via the individual lead electrode 90 and a connection wiring 121 such as a bonding wire.

The piezoelectric layer 70 continuously extends through a region opposing the plurality of pressure chamber 12, with an opening 301 to be described later formed in a portion thereof, as illustrated in FIG. 5. In other words, the piezoelectric layer 70 extends along an outer region of the end portion of the first electrode 60 in its widthwise direction. As illustrated in FIG. 3, with respect to the second direction orthogonal to the first direction (direction in which the pressure chambers are aligned), the piezoelectric layer 70 extends to an outer region of the end portion of the pressure chamber 12 in its longitudinal direction.

The second electrode 80 continuously extends, as illustrated in FIG. 5, on the piezoelectric layer 70, through a region opposing the plurality of pressure chambers 12 and the partition wall 11. Also, as already stated referring to FIG. 3, in the region opposing the pressure chamber 12 (region on the side of the nozzle opening 21 in the longitudinal direction of the pressure chamber 12), an end portion of the second electrode 80 is located so as to correspond to the pressure chamber 12. Such end portion of the second electrode 80 defines a boundary between the piezoelectric active portion 320 and the piezoelectric non-active portion 330 on one side in the longitudinal direction (on the side of the nozzle opening 21).

Also, as illustrated in FIGS. 4 and 5, the piezoelectric layer 70 and the second electrode 80 include an opening 301. The opening 301 is formed by entirely removing the second electrode 80 and the piezoelectric layer 70, and positioned so as to oppose the partition wall 11 defining the pressure chambers 12. As illustrated in FIG. 2B, the opening 301 is configured such that a length L₁ in the second direction is shorter than a length L₂ of the piezoelectric active portion 320 in its longitudinal direction (second direction), and that a width W₁ in the first direction is wider than a thickness W₂ of the partition wall 11. Thus, the piezoelectric layer 70 is almost located in a region opposing the pressure chambers 12, in the widthwise direction thereof (first direction).

Further, wiring electrodes 200, 201 are provided on the respective sides of the piezoelectric active portions 320 in the second direction, so as to continuously extend in the direction in which the piezoelectric active portions 320 are aligned, on the flow path substrate 10 (more precisely, on the vibrating plate 50). The wiring electrodes 200, 201 are connected on both sides of the piezoelectric active portion 320 in the direction in which they are aligned (first direction), thus to be mutually conductive and to be electrically connected to the second electrode 80 on the respective end portions thereof in the direction in which the piezoelectric active portions 320 are aligned.

The wiring electrodes 200, 201 thus configured are electrically connected to the second electrode 80 via the common lead electrode 91 provided between the piezoelectric active portions 320.

The common lead electrode 91 is continuously provided between the wiring electrode 200 and the wiring electrode 201, and between the adjacent piezoelectric active portions 320, so as to continuously extend, as illustrated in FIG. 4, on the vibrating plate 50, the piezoelectric layer 70, and the second electrode 80.

The common lead electrode 91 thus configured is provided on the partition wall 11 and inside the opening 301 as illustrated in FIG. 2B, and has a width W₀ narrower than the thickness W₂ of the partition wall 11 in the first direction, in the opening 301. Forming thus the common lead electrode 91 in a width W₀ narrower than the thickness W₂ of the partition wall 11 inside the opening 301 keeps the common lead electrode 91 from being located on a region of the vibrating plate 50 opposing the pressure chamber 12 in the opening 301. Here, a highly conductive metal such as gold (Au) may be suitably employed as the common lead electrode 91.

Electrically connecting thus the second electrode 80 of the piezoelectric element 300 and the wiring electrodes 200, 201 via the common lead electrode 91 can substantially reduce the resistance of the second electrode 80, thereby achieving a constantly stable ink discharging characteristic. In this embodiment, particularly, providing the common lead electrode 91 between the piezoelectric active portions 320 contributes to reducing the resistance of the wiring electrodes 200, 201, and therefore the wiring electrodes 200, 201 can be made in a narrower width (in the second direction), so that the ink jet recording head I can be made smaller in size.

Also, providing the common lead electrode 91 on the partition wall 11 inside the opening 301 contributes to increasing the rigidity of the partition wall 11. In addition, since the piezoelectric layer 70 and the second electrode 80 are not provided between the adjacent piezoelectric active portions 320 and the opening 301 is provided, what is known as a crosstalk in the piezoelectric element 300 can be suppressed. Because, when the piezoelectric element 300 is caused to be displaced, the displacement of the piezoelectric active portions 320 is not interfered by the piezoelectric layer 70 and the second electrode 80, which results in an improved displacement characteristic.

Further, providing the common lead electrode 91 on the partition wall 11, with reduced rigidity due to forming the opening 301, contributes to improving the rigidity of the partition wall 11, thereby suppressing deformation of the partition wall 11 when pressure fluctuation is caused in the pressure chamber 12 by the displacement of the piezoelectric element 300 and minimizing transmission of the pressure fluctuation to the adjacent pressure chamber 12 (crosstalk through the partition wall 11). Such a configuration allows, consequently, the partition wall 11 to be made thinner thereby contributing to increasing the density of the pressure chambers 12, hence the density of the nozzle openings 21.

In this embodiment, further, forming the common lead electrode 91 in a width narrower than the thickness of the partition wall 11 may suppress interference from the common lead electrode 91 with the displacement of the vibrating plate 50, more precisely the displacement of a boundary between a region of the vibrating plate 50 opposing the partition wall 11 and that opposing the pressure chamber 12. Here, if the common lead electrode 91 is made wider than the thickness W₂ of the partition wall 11, a portion of the common lead electrode 91 is provided on the boundary region and interferes with the displacement of the piezoelectric element 300 (vibrating plate 50), thus degrading the displacement characteristic.

Moreover, providing the common lead electrode 91 between all the piezoelectric active portions 320 as in this embodiment causes a structure with respect to each of the piezoelectric active portions 320 to be uniform. More specifically, the partition wall 11 on the respective sides of the pressure chamber 12 on which the piezoelectric active portion 320 is provided has a uniform structure, and hence all the piezoelectric active portions 320 can be driven under the same condition, which contributes to stabilizing the ink discharging characteristic.

In the piezoelectric element 300 according to this embodiment, the first electrode 60 serves as the individual electrode and the second electrode 80 serves as the common electrode, and the end portion of the first electrode 60 in the longitudinal direction of the pressure chamber 12 is covered with the piezoelectric layer 70. Such a configuration suppresses current leak between the first electrode 60 and the second electrode 80, thereby suppressing breaking down of the piezoelectric element 300. It is to be noted that in the case where the first electrode 60 and the second electrode 80 are exposed close to each other, the current leaks along the surface of the piezoelectric layer 70, thereby collapsing the piezoelectric layer 70. On the other hand, although the other end portion of the first electrode 60 in the longitudinal direction of the pressure chamber 12 is not covered with the piezoelectric layer 70, this portion is free from the current leak issue because the exposed first electrode 60 and the second electrode 80 are sufficiently distant from each other. Such a structure eliminates the need to cover the piezoelectric element 300 with a cover layer formed of, for example, aluminum oxide, thereby keeping the displacement of the piezoelectric element 300 free from interference from the cover layer and thus improving the displacement characteristic.

Referring here again to FIG. 1, a cover substrate 30 including a piezoelectric element enclosing portion 31 that is a space provided for protecting the piezoelectric element 300, is attached via an adhesive 35 to the flow path substrate 10 on which the piezoelectric element 300 configured as described above is provided. The piezoelectric element 300 is protected substantially free from an influence of external environment, because of being accommodated in the piezoelectric element enclosing portion 31. Also, the cover substrate 30 includes the manifold stem portion 32 located in a region corresponding to the communication channel 15 in the flow path substrate 10. As described above, the manifold stem portion 32 communicates with the communication channel 15 in the flow path substrate 10, thereby constituting a part of the manifold 100 serving as the common ink chamber for the pressure chambers 12.

The driving circuit 120 that drives the piezoelectric element 300 is fixed on the cover substrate 30. The driving circuit 120 may be formed of, for example, a circuit board or a semiconductor IC. The individual lead electrodes 90 and the common lead electrode 91 are led out to an outer region of the piezoelectric element enclosing portion 31, and the individual lead electrodes 90 and the common lead electrode 91 thus led out are electrically connected to the driving circuit 120 via the connection wiring 121 made of a conductive wire such as a bonding wire.

On the cover substrate 30, further, a compliance substrate 40 including a sealing film 41 and a fixing plate 42 is attached. The sealing film 41 is made of a flexible material having low rigidity, and serves to seal one of the sides of the manifold 100. The fixing plate 42 is made of a hard material such as a metal. The fixing plate 42 includes an opening 43 formed throughout the entire thickness thereof in a region opposing the manifold 100. Accordingly, the manifold 100 is sealed only by the flexible sealing film 41.

In the ink jet recording head I thus configured according to this embodiment, ink is introduced from an external ink supplier (not illustrated), and the entire flow path from the manifold 100 to the nozzle openings 21 is filled with the ink, after which a voltage is applied to the piezoelectric elements 300 corresponding to the respective pressure chambers 12 in accordance with a recording signal from the driving circuit 120 (not illustrated), to thereby deflect the piezoelectric element 300 and increase the pressure in the pressure chambers 12, so that the ink droplets are ejected through the nozzle openings 21.

### Second Embodiment

FIG. 6 is an enlarged fragmentary plan view of an ink jet recording head according to a second embodiment, exemplifying the liquid ejecting head of the invention. Hereafter, the same constituents as those of the foregoing embodiment will be given the same numeral, and description thereof will not be repeated.

As illustrated in FIG. 6, a common lead electrode 91A in this embodiment includes a narrowed portion 92 made narrower than the thickness of the partition wall 11 in the opening 301, and a wider portion 93 made wider than the thickness of the partition wall 11 outside the opening 301.

Forming thus the narrowed portion 92 in the common lead electrode 91A suppresses interference from the common lead electrode 91A with the displacement of the piezoelectric active portion 320 (vibrating plate 50), thereby suppressing degradation in displacement characteristic of the piezoelectric element 300. Also, forming the wider portion 93 in the common lead electrode 91A allows the overall resistance of the second electrode 80 to be reduced, thereby further ensuring that fluctuation of displacement characteristic arising from a voltage drop is suppressed. Further, forming the wider portion 93 in the common lead electrode 91A contributes to reducing the resistance thereof, thereby allowing the wiring electrodes 200, 201 to be made narrower.

### Other Embodiments

Although the invention has been described with reference to the foregoing embodiments, the structure of the invention is not limited to those embodiments.

For example, the wiring electrodes 200, 201 are provided on the respective sides of the row of the piezoelectric element 300 according to the foregoing embodiments. However, the wiring electrodes 200, 201 may instead be provided only on one side of the row of the piezoelectric element 300.

Although the common lead electrodes 91, 91A are disposed so as to continuously extend along the partition wall 11 between the wiring electrode 200 on one side and the wiring electrode 201 on the opposite side according to the embodiments. However, since the common lead electrodes 91, 91A are intended for improving the rigidity of the partition wall 11, which is degraded because of forming the opening 301, the common lead electrodes 91, 91A may be discontinuously provided on the second electrode 80, provided that the common lead electrodes 91, 91A are continuously formed at least on the partition wall 11 inside the opening 301. It should be noted, however, that in the case where the common lead electrodes 91, 91A are discontinuous in a region other than on the second electrode 80, the second electrode 80 and the wiring electrodes 200, 201 cannot be electrically connected.

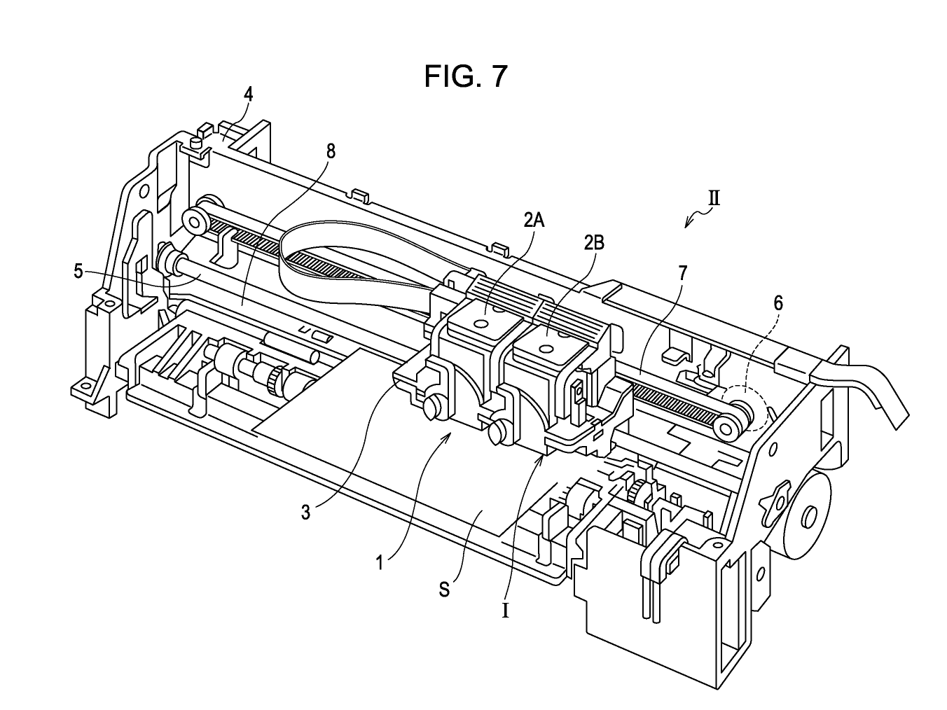

The ink jet recording head I can constitute a part of an ink jet recording head unit including an ink flow path communicating with an ink cartridge or the like, and be incorporated in an ink jet recording apparatus. FIG. 7 is a schematic perspective view illustrating such an ink jet recording apparatus.

As illustrated in FIG. 7, the ink jet recording apparatus II includes the ink jet recording head unit 1 (hereinafter simply referred to as head unit 1) including a plurality of ink jet recording heads I. The head unit 1 includes detachable cartridges 2A and 2B serving as the ink supplier, and a carriage 3 with the head unit 1 mounted thereon is provided so as to axially move along a carriage shaft 5 mounted in an apparatus main body 4. The head unit 1 is configured to discharge, for example, a black ink composition and color ink composition. When a driving force of a driving motor 6 is transmitted to the carriage 3 through a plurality of gears (not illustrated) and a timing belt 7, the carriage 3 with the recording head unit 1 mounted thereon is caused to move along the carriage shaft 5. The main body 4 includes a platen 8 provided along the carriage shaft 5, so that a recording sheet S, a recording medium such as paper supplied by a feed roller (not illustrated), is transported on the platen 8.

In the example illustrated in FIG. 7, the head unit 1 including the plurality of ink jet recording heads I is incorporated in the ink jet recording apparatus II. Alternatively, the head unit 1 including a single ink jet recording heads I may be installed in the ink jet recording apparatus II, and two or more head units 1 may be installed in the ink jet recording apparatus II. Further alternatively, the ink jet recording head I may be directly incorporated in the ink jet recording apparatus II.

Although the liquid ejecting head according to the invention is exemplified by the ink jet recording head in the above-described embodiments, the general structure of the liquid ejecting head is not limited to those embodiments. The invention is broadly applicable to various liquid ejecting heads, which naturally include those that eject a liquid other than the ink. Examples of such liquid ejecting head include a recording head for use in an image recording apparatus such as a printer, a color material ejecting head employed for manufacturing a color filter for an LCD and the like, an electrode material ejecting head employed for manufacturing an electrode in an organic EL display or a field emission display (FED), and an bioorganic ejecting head for manufacturing a biochip.

What is claimed is:

1. A liquid ejecting head comprising:
a flow path substrate including a plurality of pressure chambers communicating with nozzle openings through which a liquid is ejected, the pressure chambers being defined by a partition wall so as to be aligned in a first direction; and
a piezoelectric element including a first electrode provided on a face of the flow path substrate via a vibrating plate, a piezoelectric layer provided on the first electrode, and a second electrode provided on the piezoelectric layer,
wherein the first electrode of the piezoelectric element serves as an individual electrode corresponding to each of the pressure chambers,
the second electrode serves as a common electrode continuously formed along a plurality of piezoelectric elements,
the piezoelectric element includes a piezoelectric active portion defined by the first electrode and the second electrode and substantially acting as a driver of the piezoelectric element, the piezoelectric active portion being located in a region opposing the pressure chamber,
an opening formed by removing a portion of the second electrode and the piezoelectric layer is provided in a region of the piezoelectric element opposing the partition wall, the opening being narrower than the piezoelectric active portion in a second direction intersecting with the first direction and wider than a thickness of the partition wall in the first direction,
a wiring electrode extending in a direction in which the piezoelectric active portions are aligned is provided at least on one side in the second direction of a row of the piezoelectric active portions aligned, and
the wiring electrode and the second electrode are connected via a common lead electrode provided between the piezoelectric active portions, and the common lead electrode is provided at least on a portion of the partition wall inside the opening.

2. The liquid ejecting head according to claim 1,
wherein a portion of the common lead electrode opposing the opening is narrower than a thickness of the partition wall.

3. The liquid ejecting head according to claim 1,
wherein the wiring electrode is provided on the respective sides in the second direction of a row of the piezoelectric element aligned, and the second electrode is electrically connected to the wiring electrode on the respective sides in the second direction of the piezoelectric element, via the common lead electrode.

4. A liquid ejecting head unit comprising the liquid ejecting head according to claim 1.

5. A liquid ejecting head unit comprising the liquid ejecting head according to claim 2.

6. A liquid ejecting head unit comprising the liquid ejecting head according to claim 3.

7. A liquid ejecting apparatus comprising the liquid ejecting head unit according to claim 4.

8. A liquid ejecting apparatus comprising the liquid ejecting head unit according to claim 5.

9. A liquid ejecting apparatus comprising the liquid ejecting head unit according to claim 6.

10. A liquid ejecting apparatus comprising the liquid ejecting head according to claim 1.

11. A liquid ejecting apparatus comprising the liquid ejecting head according to claim 2.

12. A liquid ejecting apparatus comprising the liquid ejecting head according to claim 3.
